(19) United States
(12) Patent Application Publication
(10) Pub. No.: US 2004/0228744 A1
(43) Pub. Date: Nov. 18, 2004

(54) Refrigerant pump

(75) Inventors: Masao Nakano, Kouka-gun (JP); Hisao Wakabayashi, Otsu-shi (JP)

Correspondence Address: PARKHURST & WENDEL, L.L.P., 1421 PRINCE STREET, SUITE 210, ALEXANDRIA, VA, 22314-2805, US

(73) Assignee: Matsushita Elec. Ind. Co. Ltd., Kadoma-shi (JP)

(21) Appl. No.: 10/837,647

(22) Filed: May 4, 2004

(30) Foreign Application Priority Data
May 14, 2003 (JP) 2003-135210
Feb. 4, 2004 (JP) 2004-027416

(51) Int. Cl. F01C 1/02; F03C 2/00

(52) U.S. Cl. 417/410.3; 417/410.4

(57) ABSTRACT

In a refrigerant pump of the present invention, a communication hole and an annular groove of a drive shaft and a groove in a cylinder bearing are constructed so that refrigerant liquid is supplied to a bearing section, and therefore the refrigerant liquid is positively supplied to the bearing section, thus making it possible to construct a favorable slide bearing against abrasion.

### BACKGROUND OF THE INVENTION

1. Field of the Invention

The present invention relates to a refrigerant pump of a cooling apparatus which efficiently cools semiconductor devices and the like with high heat generation with use of change of phases of evaporation and condensation of a refrigerant.

2. Description of Related Art

As a conventional refrigerant pump, there is a bush bearing type (for example, see Japanese Unexamined Patent Publication No. 3-233188). FIG. 7 shows a refrigerant pump described in this Publication.

In FIG. 7, an electric motor unit 65 constituted of a rotor 63 and a stator 64, and a compression machine unit 66 are included in an inside of a hermetic container 62 provided with a discharge pipe 61. A drive shaft 68 supported by a bearing 67 mounted to the hermetic container 62 is directly connected to the rotor 63 to drive the compression machine unit 66. Reference numeral 69 is refrigerant liquid located in the hermetic container 62. Reference numeral 70 denotes a suction pipe.

In order to reduce abrasion of the drive shaft 68 and the bearing 67, a bush 71 of a copper-based porous sintered alloy material is provided. An oil groove 72 is constructed in the drive shaft 68, but it is not made actually clear how the refrigerant liquid flows.

There is a type of a refrigerant pump in which a rotor of the electric motor unit is located outside of the hermetic container, a pump mechanism unit and a rotor of an electric motor unit are located inside of the aforesaid hermetic container, the rotor and a rotor of the pump mechanism unit are connected with a drive shaft, the rotor of the pump mechanism unit is rotationally driven with a magnetic action of the stator of the electric motor unit and the rotor of the electric motor unit to pump out the refrigerant (for example, refer to Japanese Unexamined Patent Publication No. 2-283887).

FIG. 8 shows a conventional refrigerant pump described in this Publication.

In FIG. 8, a stator 72 of the electric motor unit is mounted to an outer side of a cylindrical hermetic container 71, a pump mechanism unit 73 and a rotor 74 of the electric motor unit are located inside of the hermetic container 71, the rotor 74 and a rotor 75 of the pump mechanism unit are connected with a drive shaft 76, the rotor 75 of the pump mechanism unit is rotationally driven by a magnetic action of the stator 72 of the electric motor unit and the rotor 74 of the electric motor unit, the refrigerant liquid sucked from a suction pipe 77 is passed from a pump chamber 78 via a refrigerant passage 79 formed in the rotor 74 through a hole 80 into a discharge pipe 81 to be discharged outside of the hermetic container 71.

In such a conventional refrigerant pump as shown in FIG. 7, the expensive bush 71 is used for the bearing 67, but the refrigerant pump does not have the structure which positively passes the refrigerant liquid between the drive shaft 68 and the bearing 67, and therefore they are in a boundary friction state and have a possibility of damaging a bearing surface. The conventional refrigerant pump shown in FIG. 8 is the same.

In the case of the conventional refrigerant pump shown in FIG. 8, the drive shaft 76 is supported at both sides, and therefore it becomes large as a whole, which is not preferable for the refrigerant pump which is demanded to be compact. Further, when the axes of the bearings which support the both ends are misaligned, there is the possibility that the drive shaft 76 is twisted and rotation becomes heavy. It is not easy to perform centering of the bearings supporting the both ends.

The present invention has its object to provide a refrigerant pump which has a highly reliable bearing section which is easy to work at a low price.

The present invention has another object to provide a refrigerant pump to which seizure or the like of the bearing section hardly occurs.

### SUMMARY OF THE INVENTION

In order to attain the objects, the present invention is characterized in that a refrigerant passage for passing a refrigerant liquid compressed in a pump mechanism unit to a discharge side is formed in a center of a drive shaft that connects a rotor of an electric motor unit and a rotor of the pump mechanism unit, and a communication hole continuing to an outer circumferential surface of the drive shaft from the refrigerant passage is formed at a position corresponding to a bearing section of the drive shaft.

According to this construction, part of the refrigerant liquid flowing through the refrigerant passage of the drive shaft is positively supplied to the inner circumferential surface of the bearing section via the communication hole to be able to make a slide bearing structure.

In the refrigerant pump of the present invention, a refrigerant pump in which a stator of an electric motor unit is mounted outside of a cylindrical hermetic container, a pump mechanism unit and a rotor of the electric motor unit are located inside of the hermetic container, and the rotor of the electric motor unit and a rotor of the pump mechanism unit are connected with a drive shaft. The rotor of the pump mechanism unit is rotationally driven by a magnetic action of the stator of the electric motor unit and the rotor of the electric motor unit, thereby to pump out a refrigerant. In the drive shaft, a refrigerant passage for passing a refrigerant liquid compressed in the pump mechanism unit to a discharge side is formed longitudinally in the center thereof, and a communication hole continuing to an outer circumferential surface of the drive shaft from the refrigerant passage is formed at a position corresponding to a bearing section.

Further, in the refrigerant pump of the present invention, the pump mechanism unit comprises a cylinder bearing which is located inside of the hermetic container to partition the hermetic container into a suction side and a discharge side while supporting the drive shaft, and which has a pump chamber formed on the suction side face thereof. The pump mechanism unit further comprises a rotor connected to the drive shaft and rotating inside of the pump chamber, and a suction plate mounted to the cylinder bearing to close the pump chamber and having a suction plate formed with a suction port for sucking the refrigerant liquid into the pump chamber and a discharge groove for passing the refrigerant liquid pressurized in the pump chamber to one end of the refrigerant passage formed in the center of the drive shaft.

Further, in the refrigerant pump of the present invention, the drive shaft has a groove formed along a circumferential direction of the drive shaft at a position corresponding to the bearing section, and the communication hole communicates with the refrigerant passage and the groove.

Further, in the refrigerant pump, the refrigerant liquid passage has a groove formed on an inner circumferential surface of the cylinder bearing at a position set at an angle of 180° to 270°.

Still further, in the refrigerant pump, a position of a discharge pipe for discharging the refrigerant liquid to the outside from the hermetic container is placed at an upper position above the drive shaft.

Still further, in the refrigerant pump, a cantilever structure is adopted such that the drive shaft is supported at one side with only a main bearing, and the electric motor unit constructed by the stator and the rotor is constructed by a stator and a rotor of a DC motor.

According to the present invention, the refrigerant liquid is supplied to the bearing section to provide a slide bearing, so that a refrigerant pump having a highly reliable bearing without causing boundary friction can be realized at a low cost.

### BRIEF DESCRIPTION OF THE DRAWINGS

FIG. 1 is a sectional view showing an embodiment of a refrigerant pump of the present invention;

FIG. 2 is a sectional view taken along the line A-A in FIG. 1;

FIG. 3 is a side view of a suction plate 10 of the embodiment as seen from the side of a pump chamber 13;

FIG. 4 is a sectional view of a drive shaft 11 of the embodiment;

FIG. 5 is a detailed view of a cylinder bearing 8 of the embodiment;

FIGS. 6A, 6B and 6C are detailed views of a cylinder bearing 8 of another embodiment;

FIG. 7 is a sectional view of a conventional bush bearing type refrigerant pump; and

FIG. 8 is a sectional view of a conventional twin-support bearing type refrigerant pump.

### DESCRIPTION OF THE EMBODIMENTS

Hereinafter, the present invention will be explained based on embodiments.

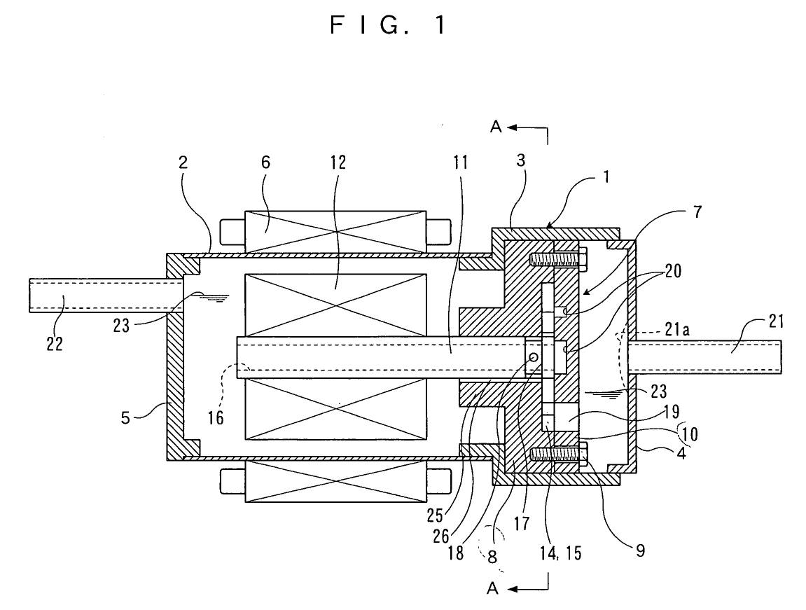

FIG. 1 to FIGS. 6A, 6B and 6C show the embodiments of the present invention.

As shown in FIG. 1, a cylindrical hermetic container 1 is formed by a thin cylindrical container 2, a thick cylindrical container 3, a suction side mirror plate 4 and a discharge side mirror plate 5.

A material of the thin cylindrical container 2 is, for example, stainless of a non-magnetic substance, and is 0.6 mm thick. The material of the thick cylindrical container 3 is, for example, stainless, and is 1.0 mm thick.

The cylindrical container 2 is joined to the cylindrical container 3 by laser welding. Laser wielding generates less heat and has less distortion, and is effective for joining them firmly.

The stator 6 of the electric motor unit is mounted to an outer side of the cylindrical container 2. A pump mechanism unit 7 is located inside of the cylindrical container 3. This pump mechanism unit 7 comprises a cylinder bearing 8 press-fitted into the cylindrical container 3, a suction plate 10 fastened with a machine screw 9 to the cylinder bearing 8 working as a bearing section, and the like.

A rotor 12 of the electric motor unit is press-fitted into a drive shaft 11 rotatably supported by the cylinder bearing 8, inside of the cylindrical container 2.

As shown in FIG. 2, a pump chamber 13 is formed in the cylinder bearing 8, and the opening is closed by the aforesaid suction plate 10. The pump chamber 13 is provided with an inner rotor 14 constituted of a trochoid curve, and an outer rotor 15 meshed with the inner rotor 14. The inner rotor 14 is fitted onto the drive shaft 11.

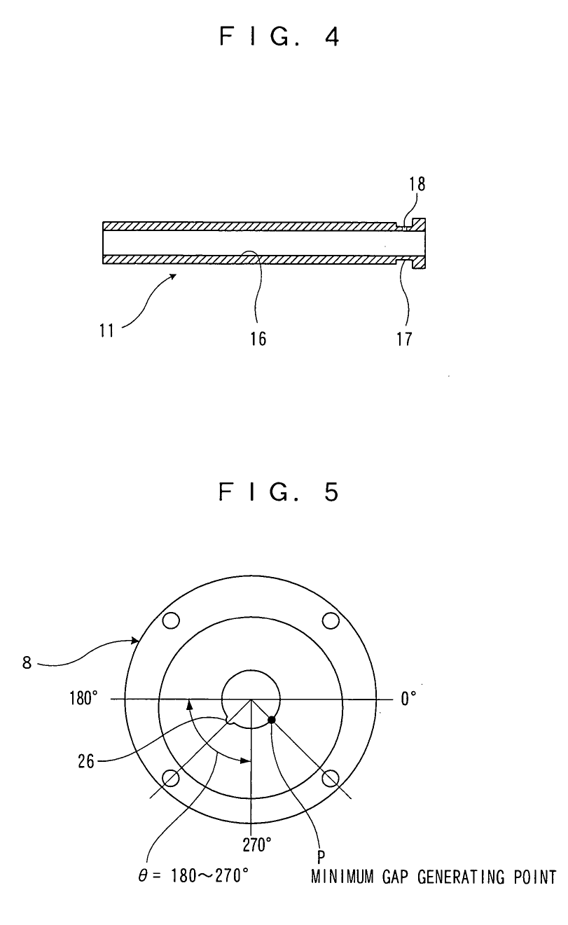

In the drive shaft 11, as shown in FIG. 4, a refrigerant passage 16 is formed longitudinally in a center from one end to the other end, and a circumferential groove that is in particular an annular groove 17, is formed at a position corresponding to a bearing section of the cylinder bearing 8. A communication hole 18 which connects the refrigerant passage 16 and the annular groove 17 is formed in the drive shaft 11.

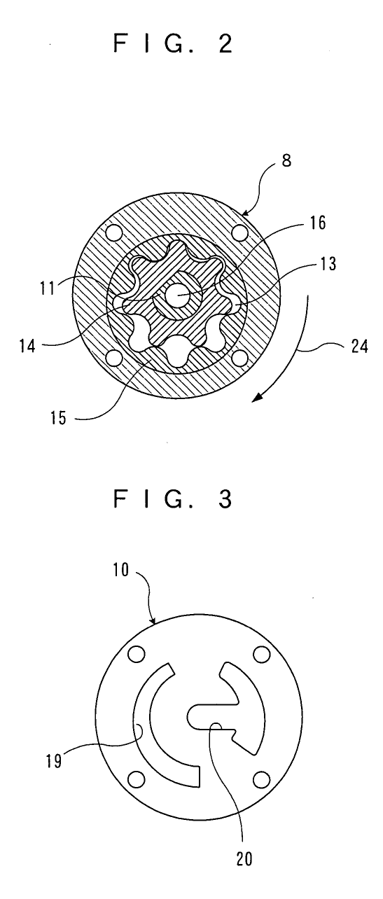

A penetrated crescent-shaped suction port 19 for sucking the refrigerant liquid into the pump chamber 13 is formed in the suction plate 10 as shown in FIG. 1 and FIG. 3. A discharge groove 20 is formed for passing the refrigerant liquid pressurized in the pump chamber 13 to the refrigerant passage 16 formed longitudinally at the center of the drive shaft 11. The discharge groove 20 is formed in an inner section of the suction plate 10 located inside of the pump chamber 13.

The suction side mirror plate 4 provided with a suction pipe 21 is mounted to an end section of the cylindrical container 3 by laser welding, and the discharge side mirror plate 5 mounted with a discharge pipe 22 is mounted to an end section of the cylindrical container 2 by laser welding. Reference numeral 23 denotes the refrigerant liquid.

As constructed above, the drive shaft 11 is rotated when the rotor 12 of the electric motor unit is rotated. Since the inner rotor 14 is fitted onto the drive shaft 11 as shown in FIG. 2, the inner rotor 14 is rotated in the direction of the arrow 24 when the drive shaft 11 is rotated.

At this time, the outer rotor 15 is meshed with the inner rotor 14, and therefore the outer rotor 15 is also rotated in the direction of the arrow 24 following the inner rotor 14. As a result, the pump chamber 13 is rotated in the direction of the arrow as it is changing in its volume to exhibit a pumping action.

When the pumping action occurs in the pump mechanism unit 7, the refrigerant liquid is sucked from the suction pipe 21 into the cylindrical container 3 via a strainer 21a. The refrigerant liquid sucked into the cylindrical container 3 is sucked into the pump chamber 13 from the suction port 19 of the suction plate 10. Then, after the refrigerant liquid rises in pressure in the pump chamber 13, it is stored in the cylindrical container 2 through the refrigerant passage 16 provided in the drive shaft 11 via the discharge groove 20 provided in the suction plate 10.

Part of the refrigerant liquid flowing through the refrigerant passage 16 in the drive shaft 11 flows into the communication hole 18 in the drive shaft 11 by a centrifugal force, and is stored in the annular groove 17 at a bottom of the drive shaft 11.

A groove 26 along a longitudinal direction of the drive shaft 11 is formed in a bearing section 25 of the cylinder bearing 8 as shown in FIG. 5, and the refrigerant liquid stored in the annular groove 17 flows through the groove 26 of the cylinder bearing 8 to be positively supplied to the bearing section to be able to construct a slide bearing favorable for abrasion.

Since the groove 26 of the cylinder bearing 8 is constructed in the range of an inner surface angle θ of the bearing section=180° to 270° as shown in FIG. 5, the region in the vicinity of the angle θ=320° where the minimum gap of the bearing exists can be avoided, and therefore contact of the drive shaft 11 and the cylinder bearing 8 can be avoided. More particularly, the bearing of this embodiment is a journal bearing, and in this type of bearing, a minimum gap generating point P theoretically occurs in the vicinity of θ≈320°. For this reason, the groove 26 is located away from the minimum gap generating point P, thus avoiding abrasion damage of the drive shaft 11 by the influence of the groove 26 to be able to secure reliability.

Since the position of the discharge pipe 22 is located at an upper section of the discharge side mirror plate 5, the refrigerant liquid is stored in the cylindrical container 2 to be able to cool the drive shaft 11 and the cylinder bearing 8, and has an operation of preventing seizure or the like of the bearing section in advance.

Since the drive shaft 11 is supported at one side by only the cylinder bearing 8, the shaft centering operation for the bearing which is needed in the conventional refrigerant pump supported at both sides is not needed, and therefore the refrigerant pump of the present invention is easy to produce and can be made compact as compared with the conventional ones.

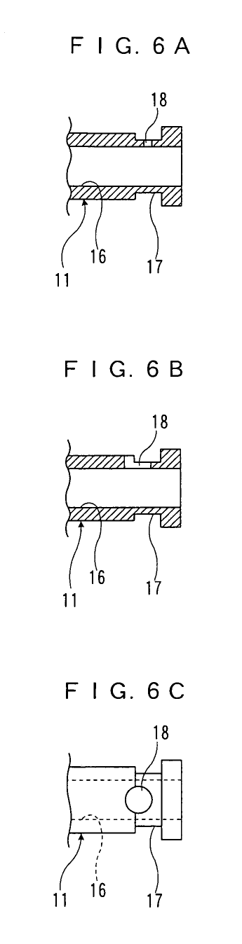

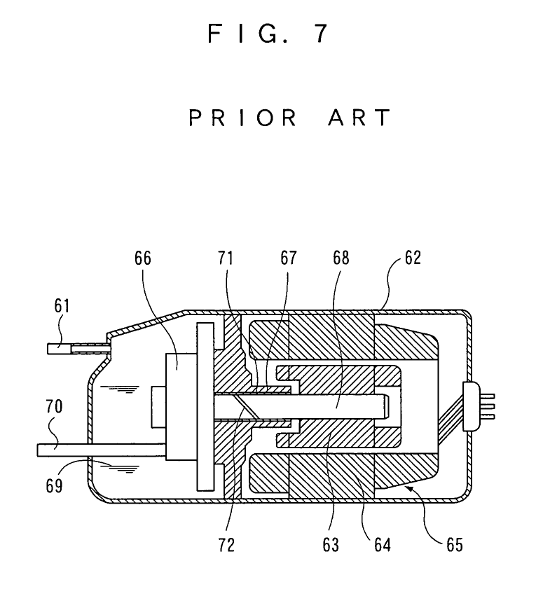

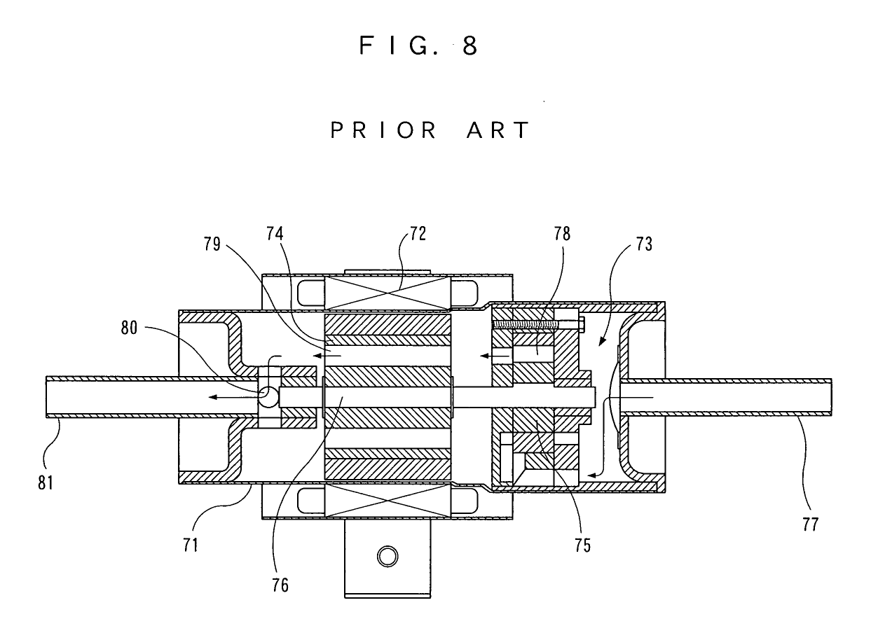

The communication hole 18 of the drive shaft 11 is smaller than the width of the annular groove 17 as shown in FIG. 6A in the above described embodiment, and when the communication hole 18 is made larger than the width of the annular groove 17 as shown in FIGS. 6B and 6C, the bearing area of the drive shaft 11 and the outflow of the refrigerant liquid from the communication hole 18 can be both secured, thus further enhancing reliability.

As the electric motor unit of each of the above-described embodiments, any of AC motor and DC motor can be adopted. However, since the supporting structure of the drive shaft 11 is the cantilever structure, and long-term rotational drive can be realized by favorable lubricating performance by outflow of refrigerant liquid, reduction in size can be further realized, in combination with the above-described cantilever supporting structure, by especially adopting a compact and light DC motor rather than using a large and heavy AC motor, when compared with the case with adoption of the AC motor.

More concretely, the refrigerant pump of each of the above-described embodiments is suitable for driving the refrigerant liquid passed into a jacket thermally connected to a CPU of a personal computer, and the temperature of the CPU was able to be reduced by 20° C. as compared with a conventional heat sink type cooling by the refrigerant pump with a DC motor being adopted, which is compact in size, 3.4 cm in diameter and 1.0 cm long with a discharge amount of 200 ml/min.

The refrigerant pump of the present invention can be used for driving refrigerant circuits used for various kinds of equipment. For example, even at a low cost, this can be used for driving a cooling refrigerant of a CPU of a personal computer or the like which requires a refrigerant pump having a highly reliable bearing section to which seizure and the like hardly occur.

1. A refrigerant pump comprising:
a stator of an electric motor unit located outside of a cylindrical hermetic container;
a pump mechanism unit and a rotor of the electric motor unit each located inside of the hermetic container; and
a drive shaft connecting the rotor of the electric motor unit and a rotor of the pump mechanism unit, the rotor of the pump mechanism unit being rotationally driven by a magnetic action of the stator of the electric motor unit and the rotor of the electric motor unit to pump out a refrigerant,
wherein the drive shaft comprises a refrigerant passage formed therein longitudinally at a center for passing a refrigerant liquid compressed in the pump mechanism unit to a discharge side is, and a communication hole formed at a position corresponding to a bearing section to continue to an outer circumferential surface of the drive shaft from the refrigerant passage.

2. The refrigerant pump according to claim 1, wherein the pump mechanism unit comprises:
a cylinder bearing located inside of the hermetic container to partition the hermetic container into a suction side and a discharge side while supporting the drive shaft, and having a pump chamber formed on the suction side face thereof;
a rotor connected to the drive shaft and rotating inside of the pump chamber; and
a suction plate mounted to the cylinder bearing to close the pump chamber, and having a suction plate formed with a suction port for sucking the refrigerant liquid into the pump chamber and a discharge groove for passing the refrigerant liquid pressurized in the pump chamber to one end of the refrigerant passage formed in the center of the drive shaft.

3. The refrigerant pump according to claim 1, wherein the drive shaft has a groove formed along a circumferential direction of the drive shaft at a position corresponding to the bearing section, and the communication hole communicates with the refrigerant passage and the groove.

4. The refrigerant pump according to claim 1, wherein the refrigerant liquid passage has a groove formed on an inner circumferential surface of the cylinder bearing at a position set at an angle of 180° to 270°.

5. The refrigerant pump according to claim 1, wherein a position of a discharge pipe for discharging outside the refrigerant liquid from the hermetic container is placed at an upper position above the drive shaft.

6. The refrigerant pump according to claim 1, wherein the drive shaft has a cantilever structure such that the drive shaft is supported at one side thereof only by a main bearing, and the electric motor unit composed of the stator and the rotor comprises a stator and a rotor of a DC motor.
